(19) United States
(12) Patent Application Publication
(10) Pub. No.: US 2021/0146669 A1
(43) Pub. Date: May 20, 2021

(54) MULTILAYER TUBE AND METHOD FOR MAKING SAME

(71) Applicant: SAINT-GOBAIN PERFORMANCE PLASTICS CORPORATION, Solon, OH (US)

(72) Inventors: Kevin M. MCCAULEY, Town of Tonawanda, NY (US); James LUDLOW, Medina, OH (US); Michael J. TZIVANIS, Chicopee, MA (US)

(21) Appl. No.: 17/097,434

(22) Filed: Nov. 13, 2020

Related U.S. Application Data
(60) Provisional application No. 62/935,968, filed on Nov. 15, 2019.

(51) Int. Cl. B32B 27/30; B32B 1/08; B32B 27/08; F16L 11/04

(52) U.S. Cl. CPC B32B 27/304; B32B 1/08; B32B 27/08; F16L 11/04; B32B 2307/714; B32B 2307/546; B32B 2250/03; B32B 2270/00; B32B 2250/24; B32B 2597/00

(57) ABSTRACT

A multilayer tube includes: an inner layer including a fluoroelastomer, wherein the fluoroelastomer has a flex modulus of less than about 40 MPa; a tie layer adjacent to the inner layer; and an outer layer adjacent to the tie layer, wherein the outer layer includes a non-fluoroelastomer.

### CROSS-REFERENCE TO RELATED APPLICATION(S)

This application claims priority under 35 U.S.C § 119(e) to U.S. Provisional Application No. 62/935,968, entitled “MULTILAYER TUBE AND METHOD FOR MAKING SAME,” by Kevin M. MCCAULEY et al., filed Nov. 15, 2019, which is assigned to the current assignee hereof and is incorporated herein by reference in its entirety.

### FIELD OF THE DISCLOSURE

This application in general, relates to a multilayer tube and a method for making same, and in particular, relates to a multilayer tube.

### BACKGROUND

Hoses and tubing are used in a variety of industries including cleaning and household industries, food processing, chemical industries, and pharmaceutical industries. In such industries, fluid conduits that have a low surface energy inner surface are used because they are easy to clean and resistant to contaminants. In particular, such industries are turning to low surface energy polymers such as fluoropolymers. However, such fluoropolymers are expensive and often have undesirable properties for certain applications.

Industry uses such fluoropolymers as liners for fluid conduit. However, many fluoropolymers desirable as an inner surface are difficult to adhere to other surfaces. For instance, when exposed to certain solvents, such as laundry detergents, delamination between a fluoropolymer and a substrate typically occurs. Further, many fluoropolymers also are inflexible, making the material undesirable for applications that require stress, such as bend radius, peristaltic pumping, pressures, and the like.

As such, an improved multilayer polymer article would be desirable.

### SUMMARY

In an embodiment, a multilayer tube includes: an inner layer including a fluoroelastomer, wherein the fluoroelastomer has a flex modulus of less than about 40 MPa; a tie layer adjacent to the inner layer; and an outer layer adjacent to the tie layer, wherein the outer layer includes a non-fluoroelastomer.

In another embodiment, a method of forming a multilayer tube includes: providing an inner layer including a fluoroelastomer, wherein the fluoroelastomer has a flex modulus of less than about 40 MPa; providing a tie layer adjacent to the inner layer; and providing an outer layer adjacent to the tie layer, the outer layer includes a non-fluoroelastomer.

In a particular embodiment, a multilayer tube includes: an inner layer including a fluoroelastomer, wherein the fluoroelastomer includes a tetrapolymer of tetrafluoroethylene (TFE), hexafluoropropylene, vinylidene fluoride, and perfluorovinyl ether, a block copolymer including at least one hard segment including monomer units of tetrafluoroethylene, ethylene, and hexafluoropropylene and at least one soft segment including monomer units of vinylidene fluoride, hexafluoropropylene, and tetrafluoroethylene, or a blend of the tetrapolymer and the block copolymer; a tie layer directly in contact with the inner layer; and an outer layer directly in contact with the tie layer, wherein the outer layer includes a diene elastomer.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary multilayer tube.

FIG. 2 includes a graphical depiction of exemplary fluoroelastomers and their physical properties.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . ” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM, unless indicated otherwise.

In a particular embodiment, a multilayer tube is provided. The multilayer tube includes at least an inner layer, a tie layer, and an outer layer. In an embodiment, the inner layer includes a fluoroelastomer. The tie layer is adjacent to the inner layer. The outer layer is adjacent to the tie layer and includes a non-fluoroelastomer. Advantageously, the multilayer tube has properties for applications that include exposure to chemical solutions, dynamic stress, or combination thereof. A method of forming a multilayer tube is further provided.

An exemplary fluoroelastomer of the inner layer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinylidene difluoride, vinyl fluoride, perfluoropropyl vinyl ether, perfluoromethyl vinyl ether, ethylene, propylene, or any combination thereof. An exemplary fluoroelastomer includes at least three monomer units, wherein the monomer units include vinylidene fluoride, hexafluoropropylene, tetrafluoroethylene, perfluoromethylvinyl ether, ethylene, or combination thereof.

In an embodiment, the fluoroelastomer includes a terpolymer of tetrafluoroethylene (TFE), hexafluoropropylene, and vinylidene fluoride. In another embodiment, the fluoroelastomer includes a tetrapolymer of tetrafluoroethylene (TFE), hexafluoropropylene, vinylidene fluoride, and perfluorovinyl ether. In a particular example, the vinylidene fluoride is present at an amount of less than about 50% by weight, such as less than about 40% by weight, such as less than about 30% by weight, or even less than about 20% by weight of the total weight of the fluoroelastomer. In an embodiment, the tetrafluoroethylene is present at an amount of greater than about 30% by weight, such as greater than about 40% by weight, such as greater than about 50% by weight, or even greater than about 60% by weight of the total weight of the fluoroelastomer. In an example, when the fluoroelastomer includes perfluorovinyl ether, the perfluorovinyl ether is present at an amount of less than about 15% by weight, such as less than about 10% by weight, such as less than about 7% by weight, or even less than about 5% by weight of the total weight of the fluoroelastomer.

In an embodiment, the fluoroelastomer includes a block copolymer including at least one hard segment and at least one soft segment. The at least one hard segment and the at least one soft segment may include any of the monomers described above. Examples of the block copolymer including the at least one hard segment is composed of monomer units of tetrafluoroethylene, ethylene, and hexafluoropropylene and the at least one soft segment is composed of monomer units of vinylidene fluoride, hexafluoropropylene, and tetrafluoroethylene. In an embodiment, the hard segment contains greater than 5% moles of ethylene, or even greater than 10% moles of ethylene. In an embodiment, the soft segment contains greater than 5% moles of vinylidene fluoride, or even greater than 10% moles of vinylidene fluoride. Any ratio of the hard segment to the soft segment is envisioned. In an embodiment, the weight ratio of the hard segment to the soft segment is 1:1 to 1:10. It will be appreciated that the ratio can be within a range between any of the minimum and maximum values noted above. In an exemplary embodiment, the durometer of the block copolymer is less than 70 shore A, such as less than 65 shore A, as measured by ASTM D2240. The melting point of the hard segment phase is less than 270° C., such as less than 260° C. Elongation at break is greater than 300%, such as greater than 400%, as measured by ASTM D412.

In an embodiment, the fluoroelastomer includes a blend of the block copolymer having at least one hard segment and at least one soft segment with another fluoroelastomer. In an embodiment, the blend includes the terpolymer of tetrafluoroethylene (TFE), hexafluoropropylene, and vinylidene fluoride. In an embodiment, the blend includes the tetrapolymer of tetrafluoroethylene (TFE), hexafluoropropylene, vinylidene fluoride, and perfluorovinyl ether. In a more particular embodiment, the blend includes the block copolymer including at least one hard segment composed of monomer units of tetrafluoroethylene, ethylene, and hexafluoropropylene and at least one soft segment composed of monomer units of vinylidene fluoride, hexafluoropropylene, and tetrafluoroethylene blended with the tetrapolymer of tetrafluoroethylene (TFE), hexafluoropropylene, vinylidene fluoride, and perfluorovinyl ether. In an embodiment, the blend includes the block copolymer at 1% by weight to 99% by weight and the tetrapolymer at 99% by weight to 1% by weight, with the proviso the total % by weight equals 100% polymer. In a more particular embodiment, the blend includes the block copolymer at 25% by weight to 75% by weight and the tetrapolymer at 75% by weight to 25% by weight, with the proviso the total % by weight equals 100% polymer. In a more particular embodiment, the blend includes the block copolymer at 50% by weight and the tetrapolymer at 50% by weight, with the proviso the total % by weight equals 100% polymer. It will be appreciated that the % by weight in the blend can be within a range between any of the minimum and maximum values noted above.

Typically, any nominal fluorine content is envisioned for the fluoroelastomer such as at least 60 weight %, such as at least 67 weight %, such as at least 70% weight %, or even at least 73 weight %. For instance, the fluoroelastomer has a nominal fluorine content of 60 weight % to 80 weight %, or even about 60 weight % to about 70 weight %. In an embodiment, the fluoroelastomer has a nominal fluorine content of 70 weight % to 80 weight %. In an example, the fluoroelastomer includes a terpolymer of ethylene, tetrafluoroethylene (TFE), and perfluoromethylvinyl ether (PMVE). In an embodiment, the terpolymer of ethylene, tetrafluoroethylene (TFE), and perfluoromethylvinyl ether (PMVE) has a nominal polymer fluorine content of at least 67 weight %, such as at least 70 weight %, or even at least 73 weight %. It will be appreciated that the nominal fluorine content can be within a range between any of the minimum and maximum values noted above. In an embodiment, the fluoroelastomer has a crystallinity of less than about 50%, such as less than about 30%, or even less than about 10%. For instance, the tetrapolymer of tetrafluoroethylene (TFE), hexafluoropropylene, vinylidene fluoride, and perfluorovinyl ether has a crystallinity of less than about 50%, such as less than about 30%, or even less than about 10%. Advantageously, the limited crystallinity provides a fluoroelastomer with flexibility and elastic recovery desirable for peristaltic pump tube applications.

In a further embodiment, the inner layer may include any additive envisioned. The additive may include, for example, a curing agent, an antioxidant, a filler, an ultraviolet (UV) agent, a dye, a pigment, an anti-aging agent, a plasticizer, the like, or combination thereof. In an embodiment, the curing agent is a cross-linking agent provided to increase and/or enhance crosslinking of one or more layers. In a further embodiment, the use of a curing agent may provide desirable properties such as decreased permeation of small molecules and improved elastic recovery of the inner layer compared to an inner layer that does not include a curing agent. Any curing agent is envisioned such as, for example, a dihydroxy compound, a diamine compound, an organic peroxide, a sulfur compound, or combination thereof. An exemplary dihydroxy compound includes a bisphenol AF. An exemplary diamine compound includes hexamethylene diamine carbamate. In an embodiment, the curing agent is an organic peroxide. Any amount of curing agent is envisioned. Alternatively, one or more layers may be substantially free of crosslinking agents, curing agents, photoinitiators, fillers, plasticizers, or a combination thereof. “Substantially free” as used herein refers to less than about 1.0% by weight, or even less than about 0.1% by weight of the total weight of the individual layer.

In a particular embodiment, the inner layer includes at least 70% by weight of the fluoroelastomer. For example, the inner layer may include at least 85% by weight fluoroelastomer, such as at least 90% by weight, at least 95% by weight, or even 100% by weight of the fluoroelastomer. In an example, the inner layer may consist essentially of the fluoroelastomer. In an example, the inner layer may consist essentially of a tetrapolymer of tetrafluoroethylene (TFE), hexafluoropropylene, vinylidene fluoride, and perfluorovinyl ether, a block copolymer including at least one hard segment composed of monomer units of tetrafluoroethylene, ethylene, and hexafluoropropylene and at least one soft segment composed of monomer units of vinylidene fluoride, hexafluoropropylene, and tetrafluoroethylene, or a blend of the tetrapolymer and the block copolymer. In an example, the inner layer may consist essentially of a tetrapolymer consisting essentially of tetrafluoroethylene (TFE), hexafluoropropylene, vinylidene fluoride, and perfluorovinyl ether, a block copolymer consisting essentially of at least one hard segment consisting essentially of monomer units of tetrafluoroethylene, ethylene, and hexafluoropropylene and at least one soft segment consisting essentially of monomer units of vinylidene fluoride, hexafluoropropylene, and tetrafluoroethylene, or a blend consisting essentially of the tetrapolymer and the block copolymer. As used herein, the phrase “consists essentially of” used in connection with the fluoroelastomer of the inner layer precludes the presence of non-fluorinated polymers and fluorinated monomers that affect the basic and novel characteristics of the fluoroelastomer, although, commonly used processing agents and additives such as antioxidants, fillers, UV agents, dyes, pigments, anti-aging agents, and any combination thereof may be used in the fluoroelastomer.

In an example, the inner layer may consist of the fluoroelastomer. In an example, the inner layer may consist of a tetrapolymer of tetrafluoroethylene (TFE), hexafluoropropylene, vinylidene fluoride, and perfluorovinyl ether, a block copolymer including at least one hard segment composed of monomer units of tetrafluoroethylene, ethylene, and hexafluoropropylene and at least one soft segment composed of monomer units of vinylidene fluoride, hexafluoropropylene, and tetrafluoroethylene, or a blend of the tetrapolymer and the block copolymer. In a particular example, the inner layer may consist of a tetrapolymer consisting of tetrafluoroethylene (TFE), hexafluoropropylene, vinylidene fluoride, and perfluorovinyl ether, a block copolymer consisting of at least one hard segment consisting of monomer units of tetrafluoroethylene, ethylene, and hexafluoropropylene and at least one soft segment consisting of monomer units of vinylidene fluoride, hexafluoropropylene, and tetrafluoroethylene, or a blend consisting of the tetrapolymer and the block copolymer.

In a particular embodiment, the fluoroelastomer has a desirable hardness. In an embodiment, the hardness of the inner layer is a shore A of less than about 95, such as about 20 to about 90, such as about 40 to about 90, such as about 40 to about 80, or even about 40 to about 65 as measured by ASTM D2240. It will be appreciated that the hardness can be within a range between any of the minimum and maximum values noted above.

The fluoroelastomer of the inner layer typically is a flexible material. For instance, the fluoroelastomer has a flexural modulus of less than about 75 MPa, such as less than about 70 MPa, such as a flexural modulus of about 20 MPa to about 70 MPa, such as about 20 MPa to about 50 MPa as measured by ASTM D790. In an embodiment, the fluoroelastomer has a flexural modulus of less than about 40 MPa, such as about 20 MPa to about 40 MPa as measured by ASTM D790. In an embodiment, the fluoroelastomer has an elongation at yield of greater than about 5%, such as greater than about 7%, such as greater than about 8%, or even greater than about 10% as measured by ASTM D790. It will be appreciated that the flexural modulus and elongation at yield can be within a range between any of the minimum and maximum values noted above.

The multilayer tube further includes a tie layer adjacent to the inner layer. In an exemplary embodiment, the tie layer includes a polymer such as a thermoplastic material or a thermoset material. For instance, the tie layer may include at least one monomer unit including an acrylate, an epoxy, an ester, an ethylene, amine, amide, tetrafluoroethylene (TFE), vinylidene fluoride (VDF), hexafluoropropylene (HFP), perfluorovinyl ether, or combination thereof. In an embodiment, the tie layer includes at least one monomer unit including an acrylate, an ethylene, or combination thereof. In an embodiment, the tie layer may be a polymer blend of a fluoropolymer of the inner layer with a polymer as described for the outer layer.

The tie layer may further include an adhesion promoter added to the polymer of the tie layer to increase the adhesion of the tie layer to at least one layer it is directly adjacent to such as, for example, the outer layer, the inner layer, or combination thereof. For instance, the adhesion promoter includes an adhesion promoter, the adhesion promoter comprising a maleic anhydride grafted PVDF, a silane-based adhesion promoter, an epoxy-based chemical, an EVOH, acrylate polymer, an acrylate copolymer, an acetal copolymer, a thermoplastic with high polarity, or combination thereof.

In an exemplary embodiment, the polymer of the tie layer may further include any reasonable additive such as a crosslinking agent, a co-agent, a photoinitiator, a filler, a plasticizer, or any combination thereof. Any co-agent is envisioned that increases and/or enhances crosslinking of the polymer composition of the tie layer. In a further embodiment, the use of a co-agent may provide desirable properties such as decreased permeation of small molecules and improved elastic recovery of the tie layer compared to a tie layer that does not include a co-agent. Any co-agent is envisioned such as, for example, bis-phenol AF, triaryl isocyanurate (TAIL), Triaryl cyanurate (TAC), an organic peroxide, or combination thereof. Any reasonable amount of co-agent is envisioned. Alternatively, the tie layer may be substantially free of crosslinking agents, co-agents, photoinitiators, fillers, plasticizers, or a combination thereof. “Substantially free” as used herein refers to less than about 1.0% by weight, or even less than about 0.1% by weight of the total weight of the polymer of the tie layer.

The multilayer tube further includes an outer layer adjacent to the tie layer. In an embodiment, the outer layer is a non-fluoroelastomer. In an embodiment, the non-fluoroelastomer of the outer layer includes any thermoplastic vulcanizate, thermoplastic polymer, thermoset polymer, or combination thereof envisioned that is free of a fluorine atom. In an embodiment, the non-fluoroelastomer of the outer layer includes a thermoplastic polyurethane, a thermoset urethane, a diene elastomer, a styrene-based elastomer, a polyolefin elastomer, a flexible polyvinyl chloride (PVC), an isoprene, a thermoplastic isoprene composite, a natural rubber, any alloy, any blend, or combination thereof.

In a particular example, the non-fluoroelastomer of the outer layer includes a diene elastomer. The diene elastomer may be a copolymer formed from at least one diene monomer. For example, the diene elastomer may be a copolymer of ethylene, propylene and diene monomer (EPDM), a thermoplastic EPDM composite, or combination thereof. An exemplary diene monomer may include a conjugated diene, such as butadiene, isoprene, chloroprene, or the like; a non-conjugated diene including from 5 to about 25 carbon atoms, such as 1,4-pentadiene, 1,4-hexadiene, 1,5-hexadiene, 2,5-dimethyl-1,5-hexadiene, 1,4-octadiene, or the like; a cyclic diene, such as cyclopentadiene, cyclohexadiene, cyclooctadiene, dicyclopentadiene, or the like; a vinyl cyclic ene, such as 1-vinyl-1-cyclopentene, 1-vinyl-1-cyclohexene, or the like; an alkylbicyclononadiene, such as 3-methylbicyclo-(4,2,1)-nona-3,7-diene, or the like; an indene, such as methyl tetrahydroindene, or the like; an alkenyl norbornene, such as 5-ethylidene-2-norbornene, 5-butylidene-2-norbornene, 2-methallyl-5-norbornene, 2-isopropenyl-5-norbornene, 5-(1,5-hexadienyl)-2-norbornene, 5-(3,7-octadienyl)-2-norbornene, or the like; a tricyclodiene, such as 3-methyltricyclo (5,2,1,0²,6)-deca-3,8-diene or the like; or any combination thereof.

In an additional example, the non-fluoroelastomer of the outer layer may include a styrene-based elastomer. The styrene-based elastomer typically includes a styrenic based block copolymer that includes, for example, a multiblock copolymer such as a diblock, triblock, polyblock, or any combination thereof. In a particular embodiment, the styrenic based block copolymer is a block copolymer having AB units. Typically, the A units are alkenyl arenes such as a styrene, an alpha-methylstyrene, para-methylstyrene, para-butyl styrene, or combination thereof. In a particular embodiment, the A units are styrene. In an embodiment, the B units include alkenes such as butadiene, isoprene, ethylene, butylene, propylene, or combination thereof. In a particular embodiment, the B units are ethylene, isoprene, or combinations thereof. Exemplary styrenic based block copolymers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. In an embodiment, the styrenic based block copolymer is saturated, i.e. does not contain any free olefinic double bonds. In an embodiment, the styrenic based block copolymer contains at least one free olefinic double bond, i.e. an unsaturated double bond. In a particular embodiment, the styrene-based elastomer is a styrene-ethylene based copolymer, a styrene isoprene based copolymer, a blend, or combination thereof.

In an example, the polyolefin elastomer of the outer layer may include a homopolymer, a copolymer, a terpolymer, an alloy, or any combination thereof formed from a monomer, such as ethylene, propylene, butene, pentene, methyl pentene, octene, or any combination thereof. An exemplary polyolefin elastomer includes high density polyethylene (HDPE), medium density polyethylene (MDPE), low density polyethylene (LDPE), ultra or very low density polyethylene (VLDPE), ethylene propylene copolymer, ethylene butene copolymer, polypropylene (PP), polybutene, polybutylene, polypentene, polymethylpentene, polystyrene, ethylene propylene rubber (EPR), ethylene octene copolymer, blend thereof, mixture thereof, and the like. The polyolefin elastomer further includes any olefin-based random copolymer, olefin-based impact copolymer, olefin-based block copolymer, olefin-based specialty elastomer, olefin-based specialty plastomer, metallocene-based olefin, blend thereof, mixture thereof, and the like.

In a particular example, the non-fluoroelastomer of the outer layer is self-bonding. For a self-bonding polymer, a modification to the non-fluoroelastomer rubber, either through grafting chemically active functionalities onto the polymeric chains within the non-fluoroelastomer rubber or through incorporation of a separated chemical component into the matrix of the non-fluoroelastomer rubber, leads to enhanced bonding between the non-fluoroelastomer rubber and the layer it is directly adjacent to. Any chemically active functionalities or chemical components are envisioned.

In an exemplary embodiment, the non-fluoroelastomer of the outer layer may further include any reasonable additive such as a curing agent, a photoinitiator, a filler, a plasticizer, or any combination thereof. Any curing agent is envisioned that increases and/or enhances crosslinking of the non-fluoroelastomer of the outer layer. In a further embodiment, the use of a curing agent may provide desirable properties such as decreased permeation of small molecules and improved elastic recovery of the outer layer compared to an outer layer that does not include a curing agent. Any curing agent is envisioned such as, for example, a sulfur compound, an organic peroxide, or combination thereof. In an embodiment, the curing agent is an organic peroxide. Any reasonable amount of curing agent is envisioned. Alternatively, the non-fluoroelastomer of the outer layer may be substantially free of a curing agent, a photoinitiator, a filler, a plasticizer, or a combination thereof. “Substantially free” as used herein refers to less than about 1.0% by weight, or even less than about 0.1% by weight of the total weight of the non-fluoroelastomer of the outer layer.

In an embodiment, the non-fluoroelastomer of the outer layer has a desirable shore hardness. In a particular embodiment, the non-fluoroelastomer of the outer layer has a shore hardness that is less than the shore hardness of the fluoroelastomer of the inner layer. In another embodiment, the non-fluoroelastomer of the outer layer has a shore hardness that is greater than the shore hardness of the fluoroelastomer of the inner layer. In yet another embodiment, the non-fluoroelastomer of the outer layer has a shore hardness that is the same as the shore hardness of the fluoroelastomer of the inner layer. In an embodiment, the hardness of the outer layer is a shore A of about 95 or less, such as about 40 to about 90, such as about 20 to about 80, such as about 40 to about 80, or even about 40 to about 60. It will be appreciated that the hardness can be within a range between any of the minimum and maximum values noted above.

In another example, the non-fluoroelastomer of the outer layer has further desirable properties. In an embodiment, the non-fluoroelastomer of the outer layer has a much higher flexibility than the inner layer as defined by a combination of durometer (or hardness), tensile strength, elongation, and flexibility tests.

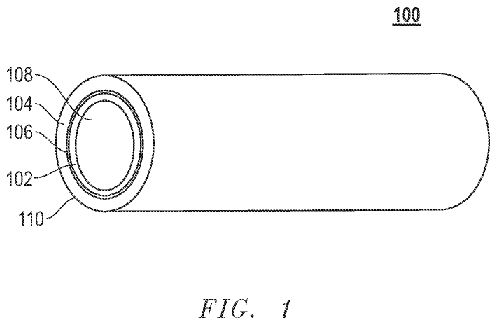

In an example, FIG. 1 includes an illustration of a multilayer flexible tube 100. In an embodiment, the tube 100 includes an inner layer 102, an outer layer 104 and a tie layer 106. For example, the inner layer 102 may directly contact the tie layer 106. In a particular example, the inner layer 102 forms an inner surface 108 of the tube. The tie layer 106 may be directly bonded to the inner layer 102 without intervening layers. In particular, the tie layer 106 is provided to increase the adhesion of the inner layer 102 to the outer layer 104. The outer layer 104 may directly contact and surround the tie layer 106. The outer layer 104 is the outer layer as described above.

Returning to FIG. 1, the inner layer 102 is thinner than the outer layer 104. For example, the total thickness of the layers of the multilayer tube 100 may be at least 3 mils to about 1000 mils, such as about 3 mils to about 500 mils, or even about 3 mils to about 100 mils. In an embodiment, the inner layer 102 has a thickness in a range of about 0.1 mil to about 100 mil, such as a range of about 0.5 mil to about 100 mil, such as a range of about 1 mil to about 100 mil, such as a range of about 1 mil to about 50 mil, such as a range of about 1 mil to about 10 mil, or even a range of about 1 mil to about 2 mil. The tie layer 106 and outer layer 104 may make up the difference. In a particular embodiment, the outer layer 204 has a thickness greater than the inner liner 202. In an example, the outer layer 104 may have a thickness in a range of about 0.1 mils to about 500 mils, such as a range of about 1 mil to about 300 mils, such as a range of about 2 mil to about 100 mils, or even a range of about 5 mil to about 50 mil. In a more particular embodiment, the inner liner 202 has a thickness that is greater than the tie layer 206. For instance, the tie layer 106 may have a thickness of about 0.01 mil to about 100 mil, such as a range of about 0.1 mil to about 100 mil, such as a range of about 0.5 mil to about 50 mil, such as a range of about 0.5 mil to about 10 mil, such as a range of about 1 mil to about 10 mil, or even a range of about 1 mil to about 5 mil. In a further example, the ratio of the thickness of the outer layer 104 relative to the thickness of the inner layer 102 is at least about 1.0, such as at least about 1.5, such as at least about 2.0, such as at least about 5.0, or even at least about 10.0. It will be appreciated that the thickness values can be within a range between any of the minimum and maximum values noted above.

While only three layers are illustrated in FIG. 1, the multilayer flexible tube 100 may further include additional layers (not illustrated). Any additional layer may be envisioned such as an additional tie layer, an elastomeric layer, a reinforcement layer, or combination thereof. Any position of the additional layer on the multilayer flexible tube 100 is envisioned. For instance, an additional elastomeric layer may be disposed on surface 110 of the outer layer 104. In another example, an additional layer such as a reinforcement layer (not shown) may be incorporated within or between additional layers disposed in proximity to surface 110 of the outer layer 104. In an embodiment, the reinforcement layer may be disposed between the inner layer 102 and the outer layer 104. An exemplary reinforcement layer may include a wire, a fiber, a fabric, such as a woven fabric, a braid, or any combination thereof, formed of a material such as polyester, an adhesion modified polyester, a polyamide, a polyaramid, a glass, a metal, or a combination thereof. In an embodiment, the multilayer tube consists of the inner layer, the tie layer, and the outer layer as described.

In a particular embodiment, the multilayer tube, such as a fluid conduit is formed by providing the inner layer including the fluoroelastomer and applying the tie layer to directly contact the bond surface of the inner layer. The fluoroelastomer may be provided by any method envisioned and is dependent upon the fluoroelastomer chosen for the inner layer. In an embodiment, the fluoroelastomer is melt processable. “Melt processable” as used herein refers to a fluoroelastomer that can melt and flow to extrude in any reasonable form such as films, tubes, fibers, molded articles, or sheets. For instance, the melt processable fluoroelastomer is a flexible material. In an embodiment, the fluoroelastomer is extruded, injection molded, or mandrel wrapped. In an exemplary embodiment, the fluoroelastomer is extruded.

In an embodiment, the tie layer is typically provided by any method envisioned and is dependent upon the material chosen for the tie layer. For instance, the tie layer may be extruded. In an embodiment, the tie layer is provided by heating the polymer to an extrusion viscosity and then extruding the polymer. In a particular embodiment, the tie layer is extruded to directly contact the fluoroelastomer inner layer.

The outer layer includes a non-fluoroelastomer as described above. The non-fluoroelastomer may be provided by any method envisioned and is dependent upon the non-fluoroelastomer chosen for the outer layer. The method may further include providing the outer layer by any method. Providing the outer layer depends on the non-fluoroelastomer material chosen for the outer layer. In an embodiment, the outer layer is a “melt processable” non-fluoroelastomer. “Melt processable non-fluoroelastomer” as used herein refers to a polymer that can melt and flow to extrude in any reasonable form such as films, tubes, fibers, molded articles, or sheets. In an embodiment, the outer layer is extruded or injection molded. In an exemplary embodiment, the outer layer may be extruded. In a particular embodiment, the outer layer is extruded over the tie layer. In an example, the outer layer is disposed to directly contact the tie layer.

In an embodiment, any combination of the inner layer, the tie layer, and the outer layer may be co-extruded. In an exemplary embodiment, the inner layer is provided by heating the fluoroelastomer to an extrusion viscosity and the outer layer is provided by heating the non-fluoroelastomer to an extrusion viscosity. In a particular embodiment, a difference of an extrusion viscosity of the fluoroelastomer of the inner layer and an extrusion viscosity of the non-fluoroelastomer of the outer layer is not greater than 25%, such as not greater than 20%, not greater than 10%, or even 0% to provide for improved processing. In a particular embodiment, the tie layer is heated to an extrusion viscosity of relative equivalence to the inner layer, the outer layer, or the difference there between. Although not being bound by theory, it is surmised that the viscosity similarity improves the adhesion of the tie layer to the inner layer and the outer layer.

Advantageously, the inner layer, tie layer, and the outer layer may also be bonded together (e.g. coextruded) at the same time, which may enhance the adhesive strength between the layers. In particular, the inner layer, the tie layer, and the outer layer have cohesive strength between the three layers, i.e. cohesive failure occurs wherein the structural integrity of the inner layer, tie layer, and the outer layer fails before the bond between the three materials fails. In a particular embodiment, the adhesive strength between the inner layer and the tie layer is cohesive. In an embodiment, the adhesive strength between the tie layer and the outer layer is cohesive.

In an embodiment, at least one layer may be treated to improve adhesion between the inner layer, the tie layer, and the outer layer. Any treatment is envisioned that increases the adhesion between two adjacent layers. For instance, a surface of the inner layer that is directly adjacent to the tie layer is treated. In an embodiment, the surface of the tie layer that is directly adjacent to the outer layer is treated. Further, a surface of the outer layer that is directly adjacent to the tie layer is treated. In an embodiment, the treatment may include surface treatment, chemical treatment, sodium etching, use of a primer, or any combination thereof. In an embodiment, the treatment may include corona treatment, UV treatment, electron beam treatment, gamma treatment, flame treatment, scuffing, sodium naphthalene surface treatment, plasma treatment, or any combination thereof.

In an embodiment, any post treatment steps may be envisioned. In particular, the post treatment step includes any thermal treatment, radiation treatment, or combination thereof. Any thermal conditions are envisioned. In an embodiment, the post treatment step includes any radiation treatment such as, for example, e-beam treatment, gamma treatment, or combination thereof. In an example, the gamma radiation or ebeam radiation is at about 0.1 MRad to about 50 MRad. In a particular embodiment, the post treatment step may be provided to eliminate any residual volatiles, increase interlayer and/or intralayer crosslinking, or combination thereof.

Although generally described as a multilayer tube, any reasonable polymeric article can be envisioned. The polymeric article may alternatively take the form of a film, a washer, or a fluid conduit. For example, the polymeric article may take the form or a film, such as a laminate, or a planar article, such as a septa or a washer. In another example, the polymeric article may take the form of a fluid conduit, such as tubing, a pipe, a hose or more specifically flexible tubing, transfer tubing, pump tubing, chemical resistant tubing, warewash tubing, laundry tubing, high purity tubing, smooth bore tubing, fluoroelastomer lined pipe, or rigid pipe, or any combination thereof. In a particular embodiment, the multilayer tube can be used as tubing or hosing where chemical resistance and pumpability is desired. For instance, a multilayer tubing is a fuel tube, a pump tube, such as for chemical or laundry detergent dispensing, a peristaltic pump tube, or a liquid transfer tube, such as a chemically resistant liquid transfer tube.

Tubing includes an inner surface that defines a central lumen of the tube. For instance, tubing may be provided that has any useful diameter size for the particular application chosen. In an embodiment, the tubing may have an outside diameter (OD) of up to about 5.0 inches, such as about 0.25 inch, 0.50 inch, and 1.0 inch. In an embodiment, the tubing may have an inside diameter (ID) of about 0.03 inches to about 4.00 inches, such as about 0.06 inches to about 1.00 inches. It will be appreciated that the inside diameter can be within a range between any of the minimum and maximum values noted above. Multilayer tubing as described advantageously exhibits desired properties such as increased lifetime. For example, the multilayer tube may have a pump life of at least about 6 months in a peristaltic pump with the pump running under intermittent conditions such with one minute on, 5 minutes off for 10 hours a day. In an embodiment, the multilayer tube has a flow rate that changes by less than about 30%, such as less than about 20%, such as less than about 10%, or even less than about 5%.

In an embodiment, the resulting multilayer tube may have further desirable physical and mechanical properties. In an embodiment, the fluoroelastomer may be particularly suited with a desirable resistance to a variety of chemical solutions. For instance, the fluoroelastomer has a percent volume change in a chemical solution with a pH of about 1 to about 14 for 168 hours at 158° F. of no greater than 20%, or even no greater than 15%. In an embodiment, the fluoroelastomer has a % change in tensile strength in a chemical solution with a pH of about 1 to about 14 for 28 days at room temperature (25° C.) of less than 15%, even less than 10%, or even less than 5%. In an embodiment, the fluoroelastomer has a % change in elongation in a chemical solution with a pH of about 1 to about 14 for 28 days at room temperature (25° C.) of less than 25%, even less than 15%, or even less than 10%. In an embodiment, the fluoroelastomer has a % change in mass in a chemical solution with a pH of about 1 to about 14 for 28 days at room temperature (25° C.) of less than 0.5%, even less than 0.3%, or even less than 0.1%. In an embodiment, the fluoroelastomer has a % change in volume in a chemical solution with a pH of about 1 to about 14 for 28 days at room temperature (25° C.) of less than 1.0%, even less than 0.5%, or even less than 0.2%. Chemical solutions with a pH of about 1 to about 14 include, for example, basic chemicals, detergents, acidic chemicals, sours, oxidizers, the like, or any combination thereof. Exemplary basic chemicals include, but are not limited to, potassium hydroxide, sodium hydroxide at 40% or less, and the like. For laundry and warewashing, these basic chemicals are typically a detergent. As for acidic chemicals, strong inorganic acids include, but are not limited to, hydrochloric acid, sulfuric acid, nitric acid, phosphoric acid, as well as weaker acids such as fluorosilicic acid and oxalic acid at 10% or less, and the like. For laundry and warewashing, these acidic chemicals are typically known as sours. Exemplary strong oxidizers include, but are not limited to, sodium hypochlorite (bleach) and organic peracids, such as peracetic acid, or combination thereof. Typically, the commercial laundry market considers these as de-stainers or bleaches. In an embodiment, the fluoroelastomer has a percent volume change in an oxidizer for 168 hours at 73° F. of no greater than 30%, such as no greater than 20%, or even no greater than 10%. In a particular embodiment, the fluoroelastomer has a percent volume change in an oxidizer, such as methanol, for 168 hours at 73° F. of no greater than 30%, such as no greater than 20%, or even no greater than 10%.

In an embodiment, the fluoroelastomer of the multilayer tube has a percent volume change in a small molecule formulation for 168 hours at 73° F. of no greater than 100%, such as no greater than 50%, or even not greater than 25%. A “small molecule formulation” includes a certain class of laundry detergents that use citrus aromas as part of their formulation. These formulations may contain, for example, alcohols, ketones, aldehydes, and other small molecules, such as citrus terpenes at less than 15%. Other small molecules include, by are not limited to isopropanol, 2-butoxy ethanol, D-limonene, citrus terpenes, dipropylene glycol monobutyl ether; glycol ether DPnB; 1-(2-butoxy-1-methylethoxy)propan-2-ol, diethylene glycol butyl ether; 2-(2-butoxyethoxy)-ethanol, fatty acids, tall-oil, sulfonic acids, C14-16-alkane hydroxyl, C14-16-alkene, sodium salt, C12-16 ethoxylated alcohols, the like, or any combination thereof.

In an embodiment, the multilayer tubes are kink-resistant and appear transparent or at least translucent. In particular, the multilayer tube has desirable flexibility and substantial clarity or translucency. For example, the multilayer tube has a bend radius of at least 0.5 inches. For instance, the multilayer tube may advantageously produce low durometer tubes. For instance, the multilayer tube may have a shore A hardness of about 95 or less, such as 20 to about 90, such as about 40 to about 90, or even about 40 to about 80, having desirable mechanical properties. In an embodiment, the materials that make up the multilayer tube have a composite flexural modulus of at least about 50 MPa, such as about 50 MPa to about 200 MPa, as measured by ASTM D790. Such properties are indicative of a flexible material. It will be appreciated that the hardness and flexural modulus can be within a range between any of the minimum and maximum values noted above.

Applications for the multilayer tubing are numerous. In an exemplary embodiment, the multilayer tubing may be used in applications such a household wares, industrial, wastewater, digital print equipment, automotive, or other applications where chemical resistance, and/or low permeation to gases and hydrocarbons are desired.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

### Embodiment 1

A multilayer tube includes: an inner layer including a fluoroelastomer, wherein the fluoroelastomer has a flex modulus of less than about 40 MPa; a tie layer adjacent to the inner layer; and an outer layer adjacent to the tie layer, wherein the outer layer includes a non-fluoroelastomer.

### Embodiment 2

A method of forming a multilayer tube includes: providing an inner layer including a fluoroelastomer, wherein the fluoroelastomer has a flex modulus of less than about 40 MPa; providing a tie layer adjacent to the inner layer; and providing an outer layer adjacent to the tie layer, the outer layer includes a non-fluoroelastomer.

### Embodiment 3

The multilayer tube or the method of forming the multilayer tube of any of the preceding embodiments, wherein the fluoroelastomer includes at least three monomer units, wherein the monomer units include vinylidene fluoride, hexafluoropropylene, tetrafluoroethylene, perfluorovinyl ether, ethylene, or combination thereof.

### Embodiment 4

The multilayer tube or the method of forming the multilayer tube of embodiment 3, wherein the fluoroelastomer includes a block copolymer including at least one hard segment and at least one soft segment.

### Embodiment 5

The multilayer tube or the method of forming the multilayer tube of embodiment 4, wherein the at least one hard segment includes monomer units of tetrafluoroethylene, ethylene, and hexafluoropropylene and the at least one soft segment includes monomer units of vinylidene fluoride, hexafluoropropylene, and tetrafluoroethylene.

### Embodiment 6

The multilayer tube or the method of forming the multilayer tube of embodiment 3, wherein the fluoroelastomer includes a terpolymer of tetrafluoroethylene (TFE), hexafluoropropylene, and vinylidene fluoride.

### Embodiment 7

The multilayer tube or the method of forming the multilayer tube of embodiment 3, wherein the vinylidene fluoride is present at an amount of less than about 50% by weight, such as less than about 40% by weight, such as less than about 30% by weight, or even less than about 20% by weight of the total weight of the fluoroelastomer.

### Embodiment 8

The multilayer tube or the method of forming the multilayer tube of embodiment 3, wherein the tetrafluoroethylene is present at an amount of greater than about 30% by weight, such as greater than about 40% by weight, such as greater than about 50% by weight, or even greater than about 60% by weight of the total weight of the fluoroelastomer.

### Embodiment 9

The multilayer tube or the method of forming the multilayer tube of embodiment 3, wherein the fluoroelastomer includes a tetrapolymer of tetrafluoroethylene (TFE), hexafluoropropylene, vinylidene fluoride, and perfluorovinyl ether.

### Embodiment 10

The multilayer tube or the method of forming the multilayer tube of embodiment 4, wherein the fluoroelastomer includes the block copolymer blended with a terpolymer of tetrafluoroethylene (TFE), hexafluoropropylene, and vinylidene fluoride, a tetrapolymer of tetrafluoroethylene (TFE), hexafluoropropylene, vinylidene fluoride, and perfluorovinyl ether, or combination thereof.

### Embodiment 11

The multilayer tube or the method of forming the multilayer tube of any of the preceding embodiments, wherein the multilayer tube has a shore A hardness of about 95 or less, such as about 40 to about 90, or even about 40 to about 80.

### Embodiment 12

The multilayer tube or the method of forming the multilayer tube of any of the preceding embodiments, wherein the inner layer has a shore A hardness of 95 or less, such as about 40 to about 90, or even about 40 to about 80.

### Embodiment 13

The multilayer tube or the method of forming the multilayer tube of any of the preceding embodiments, wherein the fluoroelastomer has a nominal polymer fluorine content of at least 67 weight %, such as at least 70 weight %, or even at least 73 weight %.

### Embodiment 14

The multilayer tube or the method of forming the multilayer tube of any of the preceding embodiments, wherein the fluoroelastomer has a crystallinity of less than about 50%, such as less than about 30%, or even less than about 10%.

### Embodiment 15

The multilayer tube or the method of forming the multilayer tube of any of the preceding embodiments, wherein the fluoroelastomer has a percent volume change in a chemical solution with a pH of about 1 to about 14 for 168 hours at 158° F. of no greater than 20%, or even no greater than 15%.

### Embodiment 16

The multilayer tube or the method of forming the multilayer tube of any of the preceding embodiments, wherein the fluoroelastomer has a percent volume change in a small molecule formulation for 168 hours at 73° F. of no greater than 100%, such as no greater than 50%, or even not greater than 25%.

### Embodiment 17

The multilayer tube or the method of forming the multilayer tube of any of the preceding embodiments, wherein the fluoroelastomer has a percent volume change in an oxidizer for 168 hours at 73° F. of no greater than 30%, such as no greater than 20%, or even no greater than 10%.

### Embodiment 18

The multilayer tube or the method of forming the multilayer tube of any of the preceding embodiments, wherein the non-fluoroelastomer includes a thermoplastic polyurethane, a thermoset urethane, a diene elastomer, a styrene butadiene rubber, a polyolefin elastomer, a PVC, an isoprene, a thermoplastic isoprene composite, a natural rubber, a blend, an alloy, or any combination thereof.

### Embodiment 19

The multilayer tube or the method of making the multilayer tube of embodiment 18, wherein the non-fluoroelastomer includes a diene elastomer, the diene elastomer including a copolymer of ethylene, propylene and diene monomer (EPDM), a thermoplastic EPDM composite, or combination thereof.

### Embodiment 20

The multilayer tube or the method of forming the multilayer tube of any of the preceding embodiments, wherein the tie layer includes at least one monomer unit including an acrylate, an epoxy, an ester, an ethylene, an amine, an amide, TFE, VDF, HFP, perfluorovinyl ether, or combination thereof.

### Embodiment 21

The multilayer tube or the method of forming the multilayer tube of any of the preceding embodiments, wherein the tie layer includes at least one monomer unit including an acrylate, an ethylene, or combination thereof.

### Embodiment 22

The multilayer tube or the method of making the multilayer tube of any of the preceding embodiments, wherein the inner layer is thinner than the outer layer.

### Embodiment 23

The multilayer tube or the method of forming the multilayer tube of any of the preceding embodiments, wherein the outer layer has a shore A hardness of about 95 or less, such as about 40 to about 90, or even about 40 to about 80.

### Embodiment 24

The multilayer tube or the method of forming the multilayer tube of any of the preceding embodiments, wherein the inner layer is disposed directly on the tie layer.

### Embodiment 25

The multilayer tube or the method of forming the multilayer tube of embodiment 24, wherein an adhesive strength between the inner layer and the tie layer is cohesive.

### Embodiment 26

The multilayer tube or the method of forming the multilayer tube of any of the preceding embodiments, wherein the outer layer is disposed directly on the tie layer.

### Embodiment 27

The multilayer tube or the method of forming the multilayer tube of embodiment 26, wherein an adhesive strength between the tie layer and the outer layer is cohesive.

### Embodiment 28

The multilayer tube or the method of forming the multilayer tube of any of the preceding embodiments, wherein the inner layer, the outer layer, or combination thereof further includes a filler.

### Embodiment 29

The multilayer tube or the method of forming the multilayer tube of any of the preceding embodiments, wherein any of the layers further includes a curing agent.

### Embodiment 30

The multilayer tube or the method of forming the multilayer tube of embodiment 29, wherein the curing agent includes a dihydroxy compound, a diamine compound, an organic peroxide, a sulfur compound, or combination thereof.

### Embodiment 31

The multilayer tube or the method of forming the multilayer tube of any of the preceding embodiments, wherein the multilayer tube is a peristaltic pump tube, a chemically resistant liquid transfer tube, a warewash tube, a laundry tube, or combination thereof.

### Embodiment 32

The multilayer tube or the method of forming the multilayer tube of any of the preceding embodiments, wherein the multilayer tube has a pump life of at least 6 months in a peristaltic pump.

### Embodiment 33

The multilayer tube or the method of forming the multilayer tube of embodiment 32, wherein the multilayer tube has a flow rate that changes by less than about 30%, such as less than about 20%, such as less than about 10%, or even less than about 5%.

### Embodiment 34

A multilayer tube includes: an inner layer including a fluoroelastomer, wherein the fluoroelastomer includes a tetrapolymer of tetrafluoroethylene (TFE), hexafluoropropylene, vinylidene fluoride, and perfluorovinyl ether, a block copolymer including at least one hard segment including monomer units of tetrafluoroethylene, ethylene, and hexafluoropropylene and at least one soft segment including monomer units of vinylidene fluoride, hexafluoropropylene, and tetrafluoroethylene, or a blend of the tetrapolymer and the block copolymer; a tie layer directly in contact with the inner layer; and an outer layer directly in contact with the tie layer, wherein the outer layer includes a diene elastomer.

### Embodiment 35

The multilayer tube of embodiment 34, wherein the diene elastomer includes a copolymer of ethylene, propylene and diene monomer (EPDM), a thermoplastic EPDM composite, or combination thereof.

### Embodiment 36

The multilayer tube of embodiment 34, wherein the tie layer includes at least one monomer unit comprising an acrylate, an epoxy, an ester, an ethylene, an amine, an amide, TFE, VDF, HFP, perfluorovinyl ether, or combination thereof.

### Embodiment 37

The method of embodiment 2, wherein providing the inner layer, the tie layer, and the outer layer includes extruding the inner layer, the tie layer, the outer layer, or combination thereof.

### Embodiment 38

The method of embodiment 37, wherein providing the inner layer, the tie layer, and the outer layer includes co-extruding the inner layer, the tie layer, the outer layer, or combination thereof.

### Embodiment 39

The method of embodiment 2, further including curing the inner layer, the tie layer, the outer layer, or combination thereof.

### Embodiment 40

The method of embodiment 2, further including applying a post treatment step including a thermal treatment, a radiation treatment, or combination thereof.

### Embodiment 41

The method of embodiment 40, wherein the radiation treatment includes e-beam treatment, gamma treatment, or combination thereof.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

Liner Materials

Compositions and Mechanical Properties:

Fluoropolymer 1-85A durometer fluoropolymer tetrapolymer THVP with monomeric units of tetrafluoroethylene (TFE), hexafluoropropylene, vinylidene fluoride, and perfluorovinyl ether.

Fluoropolymer 2 (“Modifier”, block copolymer)—60A durometer fluoropolymer based on THV and E (ethylene). The block copolymer includes hard segments (monomer composition: tetrafluoroethylene, ethylene, and hexafluoropropylene (TFE/E/HFP)=49/43/8 by mole) and fluorine-containing soft segments (monomer composition: vinylidene fluoride, hexafluoropropylene, and tetrafluoroethylene (VdF/HFP/TFE)=50/30/20 by mole) and the weight ratio of the hard segment to the soft segment=15:85).

A blending study was conducted with fluoropolymer 1 and fluoropolymer 2. The two were melt blended in a 1.5″ single screw extruder and pelletized.

Blend 1 is 25% by weight of fluoropolymer 2 added to fluoropolymer 1.

Blend 2 is 50% by weight of fluoropolymer 2 added to fluoropolymer 1.

Blend 3 is 75% by weight of fluoropolymer 2 added to fluoropolymer 1.

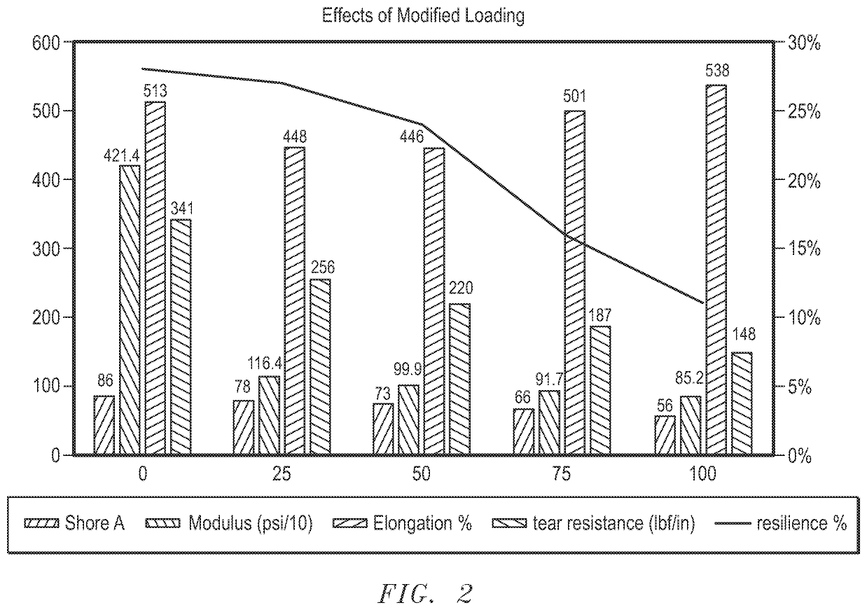

Compression molded samples of the blends and neat fluoropolymers were prepared and tested for physical properties and chemical resistance. FIG. 2 shows loading of fluoropolymer 2 into fluoropolymer 1. The x-axis is the % by weight of fluoropolymer 2 blended with fluoropolymer 1. For instance, at “0”, fluoropolymer 2 was present at 0 wt % and fluoropolymer 1 was present at 100 wt % of the blend. At “25” of the x-axis, fluoropolymer 2 was present at 25% by weight and fluoropolymer 1 was present at 75 wt % of the blend, i.e. “Blend 1”.

Addition of fluoropolymer 2 to fluoropolymer 1 significantly reduced tensile modulus (ASTM D412). Tear resistance (ASTM D1004) and durometer (ASTM D2240) of the blends showed linear response relative to the constituents. Resilience, as measured by vertical rebound (ASTM D2632), did not decline significantly until >50% loading. Conversely, addition of the tetrapolymer to the block copolymer improved resilience and tear resistance. All of the polymer blends were transparent.

Chemical Resistance

The prospective liner materials were tested for chemical resistance in a variety of chemical solutions. Examples are given in the following table, Table 1.

TABLE 1
28 DAY SOAKS

| | % change in tensile strength | | | % change elongation | | |
|---|---|---|---|---|---|---|
| | | | 50/50 | | | 50/50 |
| | Modifier | 75/25 | blend | Modifier | 75/25 | blend |
| Clothesline Fresh | −7.14% | −2.63% | −0.86% | 5.61% | 2.63% | 6.18% |
| Liquid Alkali | | | | | | |
| Citrus Clean | 3.17% | −5.07% | 1.29% | 22.48% | 11.52% | 1.43% |
| Clothesline Fresh | −13.92% | −12.35% | −2.83% | 2.97% | −0.76% | 8.11% |
| Xtreme Sour | | | | | | |
| Microtech Destainer | −9.84% | −4.53% | −10.01% | 4.53% | −2.35% | 6.31% |

| | % change in mass | | | % change in volume | | |
|---|---|---|---|---|---|---|
| | | | 50/50 | | | 50/50 |
| | Modifier | 75/25 | blend | Modifier | 75/25 | blend |
| Clothesline Fresh | −0.06% | −0.06% | −0.06% | −0.39% | −0.23% | −0.53% |
| Liquid Alkali | | | | | | |
| Citrus Clean | −0.13% | 0.10% | −0.02% | −0.31% | −0.02% | 0.03% |
| Clothesline Fresh | 0.04% | −0.01% | 0.04% | −0.47% | −0.59% | 0.11% |
| Xtreme Sour | | | | | | |
| Microtech Destainer | −0.02% | 0.00% | 0.08% | −0.24% | −0.45% | −0.11% |

Tensile bars were soaked for 28 days at room temperature (25° C.) in four different chemical solutions and then tested for tensile and elongation and mass and volume change. Table 1 above shows % change relative to unsoaked controls. The “Citrus Clean” is a small molecule; the “Microtech Destainer” is an oxidizer”; the “Clothesline Fresh Xtreme Sour” is a low pH; and the “Clothesline Fresh Liquid Alkali” is a high pH (as described above). Clearly, the materials tested had desirable chemical resistance. All fluoroelastomers tested and soaked for 28 days at room temperature had a % change in tensile strength of less than 15%, even less than 10%, or even less than 5%. All fluoroelastomers tested and soaked for 28 days at room temperature had a % change in elongation of less than 25%, even less than 15%, or even less than 10%. All fluoroelastomers tested and soaked for 28 days at room temperature had a % change in mass of less than 0.5%, even less than 0.3%, or even less than 0.1%. All fluoroelastomers tested and soaked for 28 days at room temperature had a % change in volume of less than 1.0%, even less than 0.5%, or even less than 0.2%.

Adhesion

Fluoropolymer 2 (modifier), blend 2, and blend 3 were tested for adhesion to a prospective tie-layer material. Plaques of the tie-layer material were co-compression molded with each and the resulting laminates were evaluated for adhesion. The tie-layer had no adhesion to fluoropolymer 2. The tie-layer bonded well to blend 2 and blend 3. Attempts to peel the tie-layer resulted in cohesive failure within the tie-layer.

Coextruded Tubing

The following combinations were coextruded into ABC multilayer tubing where A is the outer jacket, B is a tie layer, and C is the liner. The tubing was extruded with an inner diameter of 0.25 inch, an outer diameter of 0.450 inch. The resultant wall thickness is 0.100.

### Tubing Examples

| | layer | 1 | 2 | 3 | 4 | 5 | 6 |
|---|---|---|---|---|---|---|---|
| 55A TPV (jacket) | A | A | | A | | | A |
| 65A TPV (jacket) | A | | A | | A | A | |
| tie-layer | B | 0.002 | 0.002 | 0.002 | 0.002 | 0.002 | 0.002 |
| Blend 3 (liner) | C | 0.007 | 0.014 | | 0.007 | | |
| Blend 2 (liner) | C | | | 0.007 | | 0.007 | |
| fluoropolymer 1 | C | | | | | | 0.007 |
| liner adhesion | | yes | yes | yes | yes | yes | yes |
| peristaltic pumpable | | yes | yes | yes | yes | yes | no |

A = jacket;
B = tie;
C = liner
liner and tie-layer thickness are shown in inches
the jacket thickness is remainder of the wall thickness

### Additional Examples

Fluoropolymer 2 is blend paired with a standard THV copolymer grade as illustrated in the above examples. A THV grade having a shore durometer from 80A to 55D is substituted for the tetrapolymer grade (fluoropolymer 1).

The modifier or blends are extruded into tubing and subsequently etched using sodium ammonia or sodium naphthalene. The tubes are extrusion coated with an electrophilic polymer such as maleic anhydride or epoxy functionalized EPDM, polyethylene, or polyethylene tie-layer and an outer jacket material.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A multilayer tube comprises:
an inner layer comprising a fluoroelastomer, wherein the fluoroelastomer has a flex modulus of less than about 40 MPa;
a tie layer adjacent to the inner layer; and
an outer layer adjacent to the tie layer, wherein the outer layer comprises a non-fluoroelastomer.

2. The multilayer tube in accordance with claim 1, wherein the fluoroelastomer comprises at least three monomer units, wherein the monomer units comprise vinylidene fluoride, hexafluoropropylene, tetrafluoroethylene, perfluorovinyl ether, ethylene, or combination thereof.

3. The multilayer tube in accordance with claim 2, wherein the fluoroelastomer comprises a block copolymer comprising at least one hard segment and at least one soft segment.

4. The multilayer tube in accordance with claim 3, wherein the at least one hard segment comprises monomer units of tetrafluoroethylene, ethylene, and hexafluoropropylene and the at least one soft segment comprises of monomer units of vinylidene fluoride, hexafluoropropylene, and tetrafluoroethylene.

5. The multilayer tube in accordance with claim 2, wherein the fluoroelastomer comprises a tetrapolymer of tetrafluoroethylene (TFE), hexafluoropropylene, vinylidene fluoride, and perfluorovinyl ether.

6. The multilayer tube in accordance with claim 3, wherein the fluoroelastomer comprises the block copolymer blended with a terpolymer of tetrafluoroethylene (TFE), hexafluoropropylene, and vinylidene fluoride, a tetrapolymer of tetrafluoroethylene (TFE), hexafluoropropylene, vinylidene fluoride, and perfluorovinyl ether, or combination thereof.

7. The multilayer tube in accordance with claim 1, wherein the fluoroelastomer has a nominal polymer fluorine content of at least 67 weight %, such as at least 70 weight %, or even at least 73 weight %.

8. The multilayer tube in accordance with claim 1, wherein the fluoroelastomer has a crystallinity of less than about 50%, such as less than about 30%, or even less than about 10%.

9. The multilayer tube in accordance with claim 1, wherein the fluoroelastomer has a percent volume change in a chemical solution with a pH of about 1 to about 14 for 168 hours at 158° F. of no greater than 20%, or even no greater than 15%.

10. The multilayer tube in accordance with claim 1, wherein the fluoroelastomer has a percent volume change in a small molecule formulation for 168 hours at 73° F. of no greater than 100%, such as no greater than 50%, or even not greater than 25%.

11. The multilayer tube in accordance with claim 1, wherein the fluoroelastomer has a percent volume change in an oxidizer for 168 hours at 73° F. of no greater than 30%, such as no greater than 20%, or even no greater than 10%.

12. The multilayer tube in accordance with claim 1, wherein the non-fluoroelastomer comprises a thermoplastic polyurethane, a thermoset urethane, a diene elastomer, a styrene butadiene rubber, a polyolefin elastomer, a PVC, an isoprene, a thermoplastic isoprene composite, a natural rubber, a blend, an alloy, or any combination thereof.

13. The multilayer tube in accordance with claim 12, wherein the non-fluoroelastomer comprises a diene elastomer, the diene elastomer comprising a copolymer of ethylene, propylene and diene monomer (EPDM), a thermoplastic EPDM composite, or combination thereof.

14. The multilayer tube in accordance with claim 1, wherein the tie layer comprises at least one monomer unit comprising an acrylate, an epoxy, an ester, an ethylene, amine, amide, TFE, VDF, HFP, perfluorovinyl ether, or combination thereof.

15. The multilayer tube in accordance with claim 1, wherein the inner layer is disposed directly on the tie layer.

16. The multilayer tube in accordance with claim 1, wherein the outer layer is disposed directly on the tie layer.

17. A multilayer tube comprises:
an inner layer comprising a fluoroelastomer, wherein the fluoroelastomer comprises a tetrapolymer of tetrafluoroethylene (TFE), hexafluoropropylene, vinylidene fluoride, and perfluorovinyl ether, a block copolymer comprising at least one hard segment comprising monomer units of tetrafluoroethylene, ethylene, and hexafluoropropylene and at least one soft segment comprising monomer units of vinylidene fluoride, hexafluoropropylene, and tetrafluoroethylene, or a blend of the tetrapolymer and the block copolymer;
a tie layer directly in contact with the inner layer; and
an outer layer directly in contact with the tie layer, wherein the outer layer comprises a diene elastomer.

18. The multilayer tube of claim 17, wherein the diene elastomer comprises a copolymer of ethylene, propylene and diene monomer (EPDM), a thermoplastic EPDM composite, or combination thereof.

19. The multilayer tube of claim 17, wherein the tie layer comprises at least one monomer unit comprising an acrylate, an epoxy, an ester, an ethylene, an amine, an amide, TFE, VDF, HFP, perfluorovinyl ether, or combination thereof.

20. A method of forming a multilayer tube comprises:
providing an inner layer comprising a fluoroelastomer, wherein the fluoroelastomer has a flex modulus of less than about 40 MPa;
providing a tie layer adjacent to the inner layer; and
providing an outer layer adjacent to the tie layer, the outer layer comprises a non-fluoroelastomer.
